(19) United States
(12) Patent Application Publication
(10) Pub. No.: US 2011/0207838 A1
(43) Pub. Date: Aug. 25, 2011

(54) RECYCLED THERMOPLASTIC WITH TOUGHENER

(75) Inventor: Avelino F. Lima, North Hills, WV (US)

(73) Assignee: E.I. DU PONT DE NEMOURS AND COMPANY, Wilmington, DE (US)

(21) Appl. No.: 13/031,366

(22) Filed: Feb. 21, 2011

Related U.S. Application Data
(60) Provisional application No. 61/308,033, filed on Feb. 25, 2010.

(51) Int. Cl. C08L 77/00; C08L 51/06; C08J 11/04

(52) U.S. Cl. 521/40.5; 524/538; 524/504; 521/40

(57) ABSTRACT

Disclosed is a thermoplastic resin composition including a) 50 to 92 weight percent of a recycled thermoplastic, wherein said recycled thermoplastic includes at least 60 weight percent of a recycled polyamide selected from the group consisting of polyamide 66, polyamide 6, and copolymers having repeat units of polyamide 66 and polyamide 6; and 8 to 30 weight percent of polymer toughener, wherein said polymer toughener comprises at least one acid polymer toughener(s) wherein said polymer toughener has an averaged calculated acid number of about 10 to about 90 mg KOH/g before blending into said thermoplastic composition.

### CROSS REFERENCE TO RELATED APPLICATIONS

This application claims the benefit of U.S. Provisional Application No. 61/308,033 filed Feb. 25, 2010, now pending, the entire disclosure of which is incorporated herein by reference.

### FIELD OF INVENTION

The present invention relates to the field of recycled thermoplastic including polyamide 66 and polymeric toughener.

### BACKGROUND OF INVENTION

The recycle of thermoplastics is potentially a cost effective, and resource efficient pathway to a variety of molded thermoplastic parts. Recycled thermoplastic can be derived from many sources. One of the more plentiful and less expensive sources is polyamide 6,6 derived from carpet, such as manufacturing waste, referred to as post industrial polyamide 66 (PI PA66), or post consumer recycle polyamide 6,6 (PCR PA66).

It is well known that polyamide PCR PA66 presents challenges to create products that can replace virgin polyamide 66 (PA66) as well as post industrial PA66 due to difficulty to create a pure stream of PA66.

In the marketplace there is polyamide PCR PA66 having purities ranging from 60% to 99% nylon content. This source of polymer has been used successfully in reinforced applications. For instance U.S. Pat. No. 6,756,412 discloses a fiber reinforced thermoplastic composite.

PCR PA66 has generally not been useful for unreinforced applications requiring toughness above 7 KJ/m² at 23° C. in accordance with ISO 179 due to deleterious effect of contaminants in the PCR such as polypropylene (PP), calcium carbonate mineral, carboxylated styrene/butadiene latex, and other impurities.

Needed are toughened resins that can be produced from PCR PA66 having toughness, as measured with Notched Charpy, above 7 KJ/m².

### SUMMARY OF INVENTION

Disclosed is a thermoplastic resin composition comprising
a) 50 to 92 weight percent of a recycled thermoplastic, wherein said recycled thermoplastic comprises at least 60 weight percent of recycled polyamide selected from the group consisting of polyamide 66, polyamide 6, and copolymers having repeat units of polyamide 66 and polyamide 6; and wherein said recycled thermoplastic has a nitrogen content of at least 60% that of pure polyamide 66, said nitrogen content being determined by Nitrogen Combustion Analysis Determination Method;
b) 8 to 30 weight percent of polymer toughener, wherein said polymer toughener comprises at least one acid polymer toughener(s) wherein said polymer toughener has an averaged calculated acid number of about 10 to about 90 mg KOH/g before blending into said thermoplastic composition;
c) 0 to 42 weight percentage of virgin polyamide 66 and/or Post Industrial polyamide 66; and
d) 0 to 10 weight percent of additives selected from the group consisting of mold release, flow enhancers, thermal stabilizers, antistatic agents, blowing agents, lubricants, plasticizers, and colorant and pigments;
   wherein the weight percents of a), b), c) and d) are based on the total weight of the thermoplastic resin composition.

Further disclosed is a process for recycle of thermoplastic comprising melt blending components a) thru d), as disclosed above and forming a pellet or molded article therefrom.

### DETAILED DESCRIPTION

The thermoplastic composition comprises a recycled thermoplastic polyamide, wherein said recycled thermoplastic polyamide comprises at least 60 weight percent of recycled polyamide selected from the group consisting of polyamide 66, polyamide 6, and copolymers having repeat units of polyamide 66 and polyamide 6; and wherein said recycled thermoplastic has a nitrogen content of at least 60% that of pure polyamide 66, said nitrogen content being determined by a Nitrogen Combustion Analysis Determination Method. Preferably said recycled polyamide consists essentially of polyamide 66. Preferably said recycled polyamide comprises at least 90 weight percent, and more preferably at least 98 weight percent, of polyamide 66. Polyamide 66 refers to poly(hexamethylene hexanediamide). Polyamide 6 refers to poly(caprolactam).

The recycled thermoplastic polyamide is preferably derived from recycled carpet and/or carpet fiber. A source of the recycled thermoplastic polyamide useful in the thermoplastic composition is referred to as post consumer recycled (PCR) polyamide.

The PCR polyamide comprises at least 60 weight percent polyamide; with the remainder weight percent comprising polypropylene, rubber, fillers, and/or other additives commonly used in carpets.

Herein the weight percent polyamide within the PCR polyamide is determined by measuring the nitrogen content of the PCR polyamide by the Nitrogen Determination Method, as disclosed herein, and comparing the determined nitrogen wt to that of pure polyamide 66 standard.

The PCR polyamide may comprise at least 90 weight percent, and 98 weight percent polyamide 66; with the remainder weight percent comprising polypropylene, rubber, fillers, and/or other additives commonly used in carpets.

Suitable PCR materials have a relative viscosity of at least 30, as determined with ASTM D789 method.

The thermoplastic resin composition comprises (b) 8 to 30 weight percent of polymer toughener, wherein said polymer toughener comprises at least one acid polymer toughener(s) having reactive acid groups, wherein said polymer toughener has an averaged calculated acid number of about 10 to about 90 mg KOH/g before blending into said thermoplastic composition.

The term “acid polymer toughener(s)” as used herein refers to a rubber which has attached to it acid groups which can react with the polyamide. Such acid groups can be “attached” to a polymer toughener by grafting small molecules onto an already existing polymer or an acid copolymer can be prepared by copolymerizing a monomer containing the desired acid group with other monomers. As an example of grafting, maleic anhydride may be grafted onto a hydrocarbon rubber (such as an ethylene/propylene copolymer) using free radical grafting techniques. The resulting grafted polymer has carboxylic anhydride and/or carboxyl groups attached to it. An example of an acid copolymer is a copolymer of ethylene and a (meth)acrylate monomer containing a carboxylic acid group. By (meth)acrylate herein is meant the compound may be an acrylate, a methacrylate, or a mixture of the two.

Preferably the at least one acid polymer toughener(s) is selected from the group consisting of a) ethylene/α-olefin grafted with maleic anhydride; b) ethylene/α-olefin/diene (EPDM) terpolymer with grafted with maleic anhydride; c) block polymers consisting of styrene/ethylene-butylene/styrene triblock (SEBS) grafted with maleic anhydride; d) acid copolymers, and e) combinations thereof.

The term “acid copolymer” as used herein refers to a polymer comprising copolymerized units of an α-olefin, an α,β-ethylenically unsaturated carboxylic acid, and optionally other suitable comonomer(s) such as, an α,β-ethylenically unsaturated carboxylic acid ester,

The acid copolymer comprises copolymerized units of an α-olefin having 2 to 10 carbons and about 2 to about 30 wt%, about 5 to 25 wt %, or about 10 to about 25 wt%, of copolymerized units of an α,β-ethylenically unsaturated carboxylic acid having 3 to 8 carbons, based on the total weight of the precursor acid copolymer.

Suitable α-olefin comonomers include, but are not limited to, ethylene, propylene, 1-butene, 1-pentene, 1-hexene, 1-heptene, 3 methyl-1-butene, 4-methyl-1-pentene, styrene, and the like and mixtures of two or more of these α-olefins. Preferably, the α-olefin is ethylene.

Suitable α,β-ethylenically unsaturated carboxylic acid comonomers include, but are not limited to, (meth)acrylic acids, itaconic acids, maleic acids, maleic anhydrides, fumaric acids, monomethyl maleic acids, and mixtures of two or more of these acid comonomers. Preferably, the α,β-ethylenically unsaturated carboxylic acid is selected from (meth)acrylic acid.

The acid copolymers may further comprise copolymerized units of other comonomer(s), such as unsaturated carboxylic acids having 2 to 10, or preferably 3 to 8 carbons, or derivatives thereof. Suitable acid derivatives include acid anhydrides, amides, and esters. Esters are preferred. Specific examples of preferred esters of unsaturated carboxylic acids include, but are not limited to, methyl (meth)acrylates, ethyl (meth)acrylates, propyl (meth)acrylates, isopropyl (meth)acrylates, butyl (meth)acrylates, isobutyl (meth)acrylates, tert-butyl (meth)acrylates, octyl (meth)acrylates, undecyl (meth)acrylates, octadecyl (meth)acrylates, dodecyl (meth)acrylates, 2-ethylhexyl (meth)acrylates, isobornyl (meth)acrylates, lauryl (meth)acrylates, 2-hydroxyethyl (meth)acrylates, glycidyl (meth)acrylates, poly(ethylene glycol)(meth)acrylates, poly(ethylene glycol) methyl ether (meth)acrylates, poly(ethylene glycol) behenyl ether (meth)acrylates, poly(ethylene glycol) 4-nonylphenyl ether (meth)acrylates, poly(ethylene glycol) phenyl ether (meth)acrylates, dimethyl maleates, diethyl maleates, dibutyl maleates, dimethyl fumarates, diethyl fumarates, dibutyl fumarates, dimethyl fumarates, vinyl acetates, vinyl propionates, and mixtures of two or more thereof. Examples of preferable suitable comonomers include, but are not limited to, methyl (meth)acrylates, butyl (meth)acrylates, glycidyl (meth)acrylates, vinyl acetates, and mixtures of two or more thereof. Preferably, however, the acid copolymer does not incorporate other comonomers in any significant amount.

The acid copolymer may have a melt flow rate (MFR) of about 10 to about 1000 g/10 min, or about 20 to about 500 g/10 min, or about 40 to about 300 g/10 min, or about 50 to about 250 g/10 min, as determined in accordance with ASTM method D1238 at 190° C. and 2.16 kg.

The polymer toughener may comprise a mixture of 2 or more polymers, at least one of which must contain acid polymer toughener, as disclosed above. The other(s) may or may not contain such acid functional groups. For instance, a preferred polymer toughener for use in the compositions described herein comprises a mixture of an ethylene/octene copolymer grafted with maleic anhydride and a plastomeric polyethylene such as Engage® 8180. Another preferred polymer toughener for use in the compositions described herein comprises a mixture of an ethylene/propylene/hexadiene terpolymer grafted with maleic anhydride and a plastomeric polyethylene such as Engage® 8180. Engage® 8180 is an ethylene/1-octene copolymer available from the Dow Chemical Company (Midland, Mich., USA).

The term “polymer toughener” also includes polymers other than acid polymer tougheners, referred to as non-functional polymer tougheners. Non-functional polymer tougheners can act as a diluent to the acid polymer tougheners and include, but are not limited to, ethylene/α-olefin copolymers, ethylene/α-olefin/diene (EPDM) terpolymers, block polymers consisting of styrene/ethylene-butylene/styrene triblock (SEGS), polyurethane rubbers, copolyether esters, and ethylene copolymers comprising copolymerized units of esters of unsaturated carboxylic acids having 3 to 10 carbons. Suitable Esters of unsaturated carboxylic acids and α-olefins useful as repeat units in these non-functional polymer tougheners are the same as disclosed above for acid polymer tougheners.

The polymer toughener has an averaged calculated acid number of about 10 to about 90 mg KOH/g polymer toughener before blending into said thermoplastic composition. In other embodiments the polymer toughener has an averaged calculated acid number of about 10 to about 60 mg KOH/g, about 10 to 40 mg KOH/g, or about 15 to 60 mg KOH/g polymer toughener. Acid number is defined as the amount in milligrams of KOH needed to neutralize the acid in 1 gram of sample.

The averaged calculated acid number of the polymer toughener can be determined by weight averaging the calculated acid number of the acid polymer toughener(s) and the non-functional polymer tougheners making up the polymer toughener.

For instance, the calculated acid number of an acid copolymer having 2 weight % of acrylic acid (AA) repeat units can be determined as follows:
2 wt % copolymer can be expressed as 0.02 g AA/g of copolymer;
0.02 g AA/72 g/mole AA=2.78×10⁻⁴ mole AA; which can now be expressed as: 2.78×10⁻⁴ mole AA/1 g of copolymer;
1 mole of KOH (MW 56) neutralizes 1 mole AA; therefore (2.78×10⁻⁴ mole AA/1 g of copolymer)×56 g/mol KOH×1000 mg/g=15.6 mg KOH/1 g copolymer.
   Using similar calculations the following table can be constructed for various wt % acrylic acid copolymers:

| | Acid number (mg |
|---|---|
| Wt % AA | KOH/g copolymer |
| 0.5 | 3.9 |
| 1.0 | 7.8 |
| 2.0 | 15.6 |
| 4.0 | 31.2 |
| 8.0 | 62.8 |

The calculated acid number of a copolymer grafted with 2 weight % of maleic anhydride (MAH, MW 98) repeat units can be determined as follows:
2 wt % graft can be expressed as 0.02 g MAH/g of copolymer;
0.02 g MAH/98 g/mole MAH=2.04×10⁻⁴ mole MAH; which can now be expressed as: 2.04×10⁻⁴ mole MAH/1 g of copolymer;
2 mole of KOH (MW 56) neutralizes 1 mole MAH; therefore (2.04×10⁻⁴ mole MAH/1 g of copolymer)×56 g/mol KOH×1000 mg/g=22.9 mg KOH/1 g copolymer.

| | Acid number (mg |
|---|---|
| Wt % MAH | KOH/g copolymer |
| 0.5 | 5.72 |
| 1.0 | 11.45 |
| 2.0 | 22.9 |
| 4.0 | 45.8 |
| 8.0 | 91.6 |

Other acid functionalized copolymers can be calculated using similar method.

The weight fraction of each acid polymer and non-functional polymer toughener making up the polymer toughener is determined based on the total weight of the polymer toughener. The summation of the weight fraction times the acid number calculated for each acid polymer and non-functional polymer toughener is the averaged calculated acid number for the polymer toughener. It should be noted that the add number of non-functional polymer tougheners is by definition zero.

In another embodiment the acid number for the polymer toughener may be empirically determined by titration methods.

The thermoplastic resin composition may include 0 to 42 weight percent of virgin PA66 polyamide and/or Post Industrial PA66. Post industrial PA 66 refers to material that has been used in a manufacturing process, but has not been exposed to consumers. One source of Post industrial PA 66 NRMAMB resin consisting of greater than 98 weight percent polyamide 66, available from El. du Pont de Nemours & Co., Inc., Wilmington, Del.

The thermoplastic resin composition may include 0 to 10 weight percent of additives selected from the group consisting of mold release (e.g. aluminum distearate, [AlSt]), flow enhancers (e.g. phthalic anhydride, adipic acid, terephthalic acid), thermal stabilizers (e.g. potassium halides/CuI/AlSt triblends and hindered phenols), antistatic agents, blowing agents, lubricants, plasticizers, and colorant and pigments.

The thermoplastic resin composition has a Notched Charpy at 23° C., of at least 7 KJ/m², and preferably 8 KJ/m², 10 KJ/m², and 11 KJ/m², in accordance with ISO 179 Method.

In one embodiment the thermoplastic resin composition has no fibrous reinforcing agent, and in another embodiment the thermoplastic resin composition has no glass fiber present. The thermoplastic resin composition may consist essentially of components a) thru d), in the ranges as disclosed above.

The thermoplastic resin composition is a mixture by melt-blending, in which all polymeric ingredients are adequately mixed, and all non-polymeric ingredients are adequately dispersed in a polymer matrix.

Another embodiment is a process for recycling a thermoplastic comprising
melt blending:
a) 50 to 92 weight percent of a recycled thermoplastic, wherein said recycled thermoplastic comprises at least 60 weight percent of recycled polyamide selected from the group consisting of polyamide 66, polyamide 6, and copolymers having repeat units of polyamide 66 and polyamide 6; and wherein said recycled thermoplastic has a nitrogen content of at least 60% that of pure polyamide 66, said nitrogen content being determined by a Nitrogen Combustion Analysis Determination Method;
b) 8 to 30 weight percent of polymer toughener, wherein said polymer toughener comprises at least one acid polymer toughener(s) wherein said polymer toughener has an averaged calculated acid number of about 10 to about 90 mg KOH/g before blending into said thermoplastic composition;
c) 0 to 42 weight percentage of virgin polyamide 66 and/or Post Industrial polyamide 66; and
d) 0 to 10 weight percent of additives selected from the group consisting of mold release, flow enhancers, thermal stabilizers, antistatic agents, blowing agents, lubricants, plasticizers, and colorant and pigments;

wherein the weight percents of a), b), c) and d) are based on the total weight of the thermoplastic resin composition; and

forming a pellet or molded article from said melt blend.

The preferences for said recycled polyamide in the process are the same as stated above for the thermoplastic resin composition.

Any melt-blending method may be used for mixing polymeric ingredients and non-polymeric ingredients of the present invention. For example, polymeric ingredients and non-polymeric ingredients may be fed into a melt mixer, such as single screw extruder or twin screw extruder, agitator, single screw or twin screw kneader, or Banbury mixer, and the addition step may be addition of all ingredients at once or gradual addition in batches. When the polymeric ingredient and non-polymeric ingredient are gradually added in batches, a part of the polymeric ingredients and/or non-polymeric ingredients is first added, and then is melt-mixed with the remaining polymeric ingredients and non-polymeric ingredients that are subsequently added, until an adequately mixed composition is obtained. Extrusion of the melt-blend through a plurality of orifices provides strands that may be chopped to provide pellets.

Another embodiment is a shaped article comprising the thermoplastic resin composition as disclosed above. Shaped articles include injection molded blow molded and extruded articles.

### Methods

### Compounding and Molding Methods

The compositions listed in Table 1 were fed to the rear of a 40 mm co-rotating twin screw extruder fitted with a moderately hard working screw run at 300-330 rpms with a 200 lb/hr feed rate; with the exception that components designated as “side fed” in Table 1 were added at barrel #6 of the extruder. The barrel temperature was set at 280° C. when virgin (referred to as Polyamide 66) or post industrial PA 66 was used (C-1 and C-2); and 320° C. when PCR polyamide 66 was used (Example 1, 2, 3 and C-3 and C-4). The hand melt temperature for Examples 1, 2, and 3 were 305, 306, and 272° C., respectively. The hand melt temperature for Comparative Examples C-1, C-2, C-3 and C-4 were 285, 277, 268, and 272° C., respectively.

Examples 1-2 and Comparative Examples C1-C3 contained, on a weight percent basis: polyamide 66 (nominal) 87 wt %, polymer toughener 11 wt %, and additives at about 1.0 wt %. Example 3 and Comparative Example C4 contained 8 wt % polymer toughener. The ratio of acid polymer toughener to non-functional polymer toughener (APT:N-FP) in each example is listed in Table 1.

### Sample Preparation and Physical Testing

The compositions were pelletized after exiting the extruder. After drying pellets overnight using a nitrogen bleed, the pellets were injection molded in a Demag #2 injection molding machine at a melt temperature of 287-293° C. and a mold temperature of 77-83° C. to provide 4 mm ISO all-purpose bars. The bars were vacuum sealed in a foil lined plastic bag to preserve them in the dry-as-molded (DAM) condition until they were cut and after conditioning in accordance with ISO 179 Method, specimens were tested for Notched Charpy at 23° C.

Tensile strength, elongation at break, and tensile modulus were tested dry as molded on a tensile tester by ISO 527 −1/−2 at 23° C. and stain rate of 50 mm/min at room temperature.

### Nitrogen Determination Method

This method is applicable to the direct measurement of nitrogen in nylon and other raw materials. For % nitrogen, the calculation is based on the N content of PA 66 (theoretical 12.38% N). An example of a pure polyimide 66 standard is Zytel® 101 resin available from E. I. du Pont de Nemours & Co., Inc. Wilmington, Del., USA. Method calculations can be used to report results as wt % nylon, and/or wt % nitrogen.

Recycled thermoplastic pellets are combusted in the LECO furnace at 850-950° C. Combustion gases are filtered, water vapor is removed and the nitrogen oxides are reduced to N₂ gas in the reduction furnace. Thermal conductivity detection is used to detect and quantify the N₂ gas produced. The analyzer is standardized using the base nylon characteristic of the compounded resin pellets (PA 66). Since rubber tougheners and other non-nylon ingredients do not contribute nitrogen, the measured decrease in detected nitrogen relative to the base nylon standard is proportional to non-nylon content concentration.

### Materials

Lubricant refers to aluminum stearate purchased from Chemtura Corporation,199 Benson Rd, Middlebury, Conn. 06749.

Engage® 8180 elastomer is an non-functional polymer toughener consisting of ethylene/1-octene copolymer available from Dow Chemical Company (Midland, Mich., USA).

Copper HS A is a heat stabilizer consisting of 7 parts potassium iodide, 1 part cuprous (I) iodide and 0.5 part aluminum distearate was purchased from Shepherd Chemical Co. (Shepherd Norwood, 4900 Beech Street, Norwood, Ohio 45212).

Copper HS B is a heat stabilizer consisting of 7 parts potassium bromide, 1 part cuprous (I) iodide and 0.5 part aluminum distearate was purchased from Shepherd Chemical Co. (Shepherd Norwood, 4900 Beech Street, Norwood, Ohio 45212).

C-Black 1 refers to ZYTFE3800 black concentrate provided by E. I. du Pont de Nemours & Co., Inc. (Wilmington, Del., USA).

C-Black 2 refers to ZYTFE31003 carbon black concentrate provided by E. I. du Pont de Nemours & Co., Inc. (Wilmington, Del., USA).

PA:ALDS refers to a blend containing 9 parts phthalic anhydride and 1 part aluminum stearate supplied by PolyAd Services, Inc., 4170 Shoreline Drive, Earth City, Mo. 63045.

Adipic acid was supplied by Invista, Inc., Orange, Tex.

Terephthalic acid was supplied by Amoco Chemicals, Naperville, Ill.

Acid polymer toughener-1 (APT-1) is an ethylene/Octane copolymer grafted with 2.0 wt % maleic anhydride, provided by E. I. du Pont de Nemours & Co., Inc. (Wilmington, Del., USA).

Fusabond® P613 resin refers to a maleic anhydride functionalized polypropylene resin available from E. I. du Pont de Nemours & Co., Inc. (Wilmington, Del., USA).

Polyamide 66 refers to Zytel® ZYT101 NC010 polyamide 66 resin available from E. I. du Pont de Nemours & Co., Inc. (Wilmington, Del., USA).

Post industrial PA 66 refers to NRMAMB consisting of greater than 98 weight percent polyamide 66, available from E.I. du Pont de Nemours & Co., Inc., Wilmington, Del.

PCR-1 Polyamide 66 refers N-66S-B post consumer recycled polyamide 66, having a polyamide 66 content based on nitrogen analysis of 97 weight percent, derived from post consumer recycled carpet, available from Shaw Industries, 330 Brickyard Rd., Dalton, Ga. 30720.

PCR-2 Polyamide 66 refers post consumer recycled polyamide 66, having a polyamide 66 content based on nitrogen analysis of 75 weight percent, derived from post consumer recycled carpet, available from Columbia Recycling Corp., Dalton, Ga. 30722.

Examples 1 and 2 show that compositions having polymer toughener with acid number of greater than 10 mg KOH/g exhibit high Notched Charpy kJ/m² impact strength. Whereas Comparative Example 3 having the same level of PCR polyamide and polymer toughener, but the polymer toughener having less than 10 mg KOH/g shows significantly less Notched Charpy kJ/m² impact strength.

Example 3 shows that a composition having a PCR with around 60 wt % polyamide and having polymer toughener with acid number of greater than 10 mg KOH/g exhibit high Notched Charpy kJ/m² impact strength. Whereas Comparative Example 4 having the same level of PCR polyamide and polymer toughener, but the polymer toughener having less than 10 mg KOH/g shows significantly less Notched Charpy kJ/m² impact strength.

TABLE 1

| Example | 1 | 2 | C-1 | C-2 | C-3 | 3 | C-4 |
|---|---|---|---|---|---|---|---|
| Post industrial PA 66 | | | 28.11 | 27.66 | | | 28.11 |
| Post industrial PA 66 | | | 39 | 39 | | | |
| (side fed) | | | | | | | |
| Polyamide 66 | | | 20 | 20 | | 40 | 40 |
| PCR-1 Polyamide 66 | 66.65 | 66.65 | | | 46.66 | | |
| PCR-2 Polyamide 66 | | | | | | 50.4 | 50.4 |
| PCR-1 Polyamide 66 | 20 | 20 | | | 40 | | |
| (side fed) | | | | | | | |
| C-Black 1 | | | 1 | | | | |
| C-Black 2 | 1 | 1 | | 1 | 1 | 1 | 1 |
| APT-1 | 8.75 | 11.65 | 5.6 | 3 | 3 | 8 | |
| Fusabond P613 | | | | | | | 8.0 |
| Engage ® 8180 | 2.9 | | 5.6 | 8.75 | 8.75 | | |
| Lubricant | 0.1 | 0.1 | 0.1 | 0.1 | 0.1 | 0.1 | 0.1 |
| Copper HS A | 0.3 | 0.3 | | | | 0.3 | 0.3 |
| Copper HS B | | | 0.29 | 0.29 | 0.29 | | |
| Adipic acid | 0.3 | 0.3 | | | | 0.3 | 0.2 |
| Terephthalic acid | | | 0.3 | | | | |
| PA:ALDS (9:1) | | | | 0.2 | 0.2 | | |
| APT:N-FP ratio | 3:1 | 1:0 | 1:1 | 1:3 | 1:3 | 1:0 | 1:0 |
| Notched Charpy kJ/m² | 17.7 | 18.1 | 18.7 | 15.7 | 10.4 | 11.3 | 3.6 |
| Tensile Strength at | 57 | 58 | 51 | 51 | 58 | 54 | 71 |
| Break (MPa) | | | | | | | |
| Tensile Strength at | 63 | 63 | 65 | 66 | 63 | 56 | 73 |
| Yield (MPa) | | | | | | | |
| Elongation at | 21 | 29 | 31 | 37 | 22 | 49 | 9 |
| Break (%) | | | | | | | |
| acid number in | 17.2 | 22.9 | 11.5 | 5.8 | 5.8 | 22.9 | 5.72 |
| polymer toughener | | | | | | | |
| (mg KOH/g) | | | | | | | |

We claim:

1. A thermoplastic resin composition comprising
a) 50 to 92 weight percent of a recycled thermoplastic, wherein said recycled thermoplastic comprises at least 60 weight percent of recycled polyamide selected from the group consisting of polyamide 66, polyamide 6, and copolymers having repeat units of polyamide 66 and polyamide 6; and wherein said recycled thermoplastic has a nitrogen content of at least 60% that of a pure. polyamide 66 standard, said nitrogen content being determined by a Nitrogen Combustion Analysis Determination Method.
b) 8 to 30 weight percent of polymer toughener, wherein said polymer toughener comprises at least one acid polymer toughener(s) wherein said polymer toughener has an averaged calculated acid number of about 10 to about 90 mg KOH/g before blending into said thermoplastic composition;
c) 0 to 42 weight percentage of virgin polyamide 66 and/or Post Industrial polyamide 66; and
d) 0 to 10 weight percent of additives selected from the group consisting of mold release, flow enhancers, thermal stabilizers, antistatic agents, blowing agents, lubricants, plasticizers, and colorant and pigments;
wherein the weight percents of a), b), c) and d) are based on the total weight of the thermoplastic resin composition.

2. The Thermoplastic resin composition of claim 1 wherein said recycled polyamide consists essentially of polyamide 66.

3. The thermoplastic resin composition of claim 1 wherein said recycled thermoplastic comprises at least 90 weight percent of polyamide 66.

4. The thermoplastic resin composition of claim 1 wherein said acid polymer toughener(s) are selected from the group consisting of A) ethylene/α-olefin grafted with maleic anhydride; B) ethylene/α-olefin/diene (EPDM) terpolymer with grafted with maleic anhydride; C) block polymers consisting of styrene/ethylene-butylene/styrene triblock (SEBS) grafted with maleic anhydride; D) acid copolymers, and combinations thereof.

5. A shaped article comprising the thermoplastic resin composition of claim 1.

6. A process for recycling a thermoplastic comprising melt blending:
a) 50 to 92 weight percent of a recycled thermoplastic, wherein said recycled thermoplastic comprises at least 60 weight percent of recycled polyamide selected from the group consisting of polyamide 66, polyamide 6, and copolymers having repeat units of polyamide 66 and polyamide 6; and wherein said recycled thermoplastic has a nitrogen content of at least 60% that of a pure polyamide 66 standard, said nitrogen content being determined by a Nitrogen Combustion Analysis Determination Method;
b) 8 to 30 weight percent of polymer toughener, wherein said polymer toughener comprises at least one acid polymer toughener(s) wherein said polymer toughener has an averaged calculated acid number of about 10 to about 90 mg KOH/g before blending into said thermoplastic composition;
c) 0 to 42 weight percentage of virgin polyamide 66 and/or Post Industrial polyamide 66; and
d) 0 to 10 weight percent of additives selected from the group consisting of mold release, flow enhancers, thermal stabilizers, antistatic agents, blowing agents, lubricants, plasticizers, and colorant and pigments
wherein the weight percents of a), b), c) and d) are based on the total weight of the thermoplastic resin composition; and
forming a pellet or molded article from said melt blend.

7. The process of claim 6 wherein said recycled polyamide consists essentially of polyamide 66.

8. The thermoplastic resin composition of claim 1 wherein said recycled thermoplastic comprises at least 90 weight percent of polyamide 66.

9. The process of claim 6 wherein said acid polymer toughener(s) are selected from the group consisting of A) ethylene/α-olefin grafted with maleic anhydride; B) ethylene/α-olefin/diene (EPDM) terpolymer with grafted with maleic anhydride; C) block polymers consisting of styrene/ethylene-butylene/styrene triblock (SEBS) grafted with maleic anhydride; D) acid copolymers, and combinations thereof.
